(19) United States
(12) Patent Application Publication
(10) Pub. No.: US 2008/0038079 A1
(43) Pub. Date: Feb. 14, 2008

(54) Adjustable concrete drop-in anchor

(76) Inventor: James L. Bobon, Fredericksburg, VA (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/503,148

(22) Filed: Aug. 14, 2006

(51) Int. Cl. F16B 13/06

(52) U.S. Cl. 411/57.1

(57) ABSTRACT

An adjustable drop-in concrete anchor includes a substantially cylindrical tubular base, the base having a lower end portion having a plurality of longitudinally extending slots defining a plurality of longitudinally extending expansion walls having a wall thickness greater than a wall thickness of the base above the lower end portion, and having an internally threaded upper end portion. The anchor includes an expander plug having at least portion having an outside diameter slightly less than an inside diameter of the base above the lower end portion and greater than an inside diameter of the base at the lower end portion. An adjustment insert disk has external threads extending around at least part of an outer circumferential surface thereof, the external threads mating with the internally threaded upper end portion of the base, and having a slot extending from a portion of the circumferential surface to at least a central axis thereof. A slidable nut is included and has an outer sliding portion for sliding in the slot in the adjustment insert and an internally threaded portion.

### BACKGROUND OF THE INVENTION

Concrete drop-in anchors are female concrete anchors designed for anchoring objects by into concrete by securing the object to the anchor, usually by a bolt screwed into a threaded female fitting in the anchor that has previously been dropped into a predrilled hole in concrete and set using a setting tool that expands the anchor in the concrete.

Many objects to be anchored into concrete, such as compressors for example, have a plurality of fixed anchor locations. It is often difficult to drill the holes for the concrete anchors accurately, i.e., at exactly the correct location, so that the plurality of fixed anchor locations on the object mate exactly with the anchors once they are dropped and set in the holes. This often leads to misalignment (in the plane of the concrete surface) between the fixed anchor locations and the anchors.

Moreover, frequently the concrete and/or the object to be fixed thereto does not have a perfectly flat mating surface, resulting in misalignment (in a direction perpendicular to the plane of the concrete surface) between the fixed anchor locations and the anchors.

Accordingly, it is desirable to have a concrete drop-in anchor that is adjustable both in the plane of the concrete surface and in a direction perpendicular to the plane of the concrete surface.

### SUMMARY OF THE INVENTION

The present invention relates to an adjustable drop-in concrete anchor includes a substantially cylindrical tubular base, the base having a lower end portion having a plurality of longitudinally extending slots defining a plurality of longitudinally extending expansion walls having a wall thickness greater than a wall thickness of the base above the lower end portion, and having an internally threaded upper end portion. The anchor includes an expander plug having at least portion having an outside diameter slightly less than an inside diameter of the base above the lower end portion and greater than an inside diameter of the base at the lower end portion. An adjustment insert disk has external threads extending around at least part of an outer circumferential surface thereof, the external threads mating with the internally threaded upper end portion of the base, and having a slot extending from a portion of the circumferential surface to at least a central axis thereof. A slidable nut is included and has an outer sliding portion for sliding in the slot in the adjustment insert and an internally threaded portion.

### BRIEF DESCRIPTION OF THE SEVERAL VIEWS OF DRAWINGS

FIG. 1 is a perspective view showing the adjustable drop-in concrete anchor of the present invention;

FIG. 2A is a top plan view thereof showing the slidable nut in a position aligned with an axis of the base;

FIG. 2B is a top plan view thereof showing the slidable nut in a position eccentric with respect to an axis of the base;

FIG. 3 is a cross-sectional view taken along line 3-3 of FIG. 2A;

FIG. 4 is a bottom plan view of the base thereof;

FIG. 5 is a cross-sectional view of the base thereof;

FIG. 6A is a side view of the slidable nut thereof;

FIG. 6B is a cross-sectional view of the slidable nut taken along line 6B-6B of FIG. 6A; and

FIG. 7 is an exploded view of the adjustable drop-in concrete anchor of the present invention.

### DETAILED DESCRIPTION OF THE INVENTION

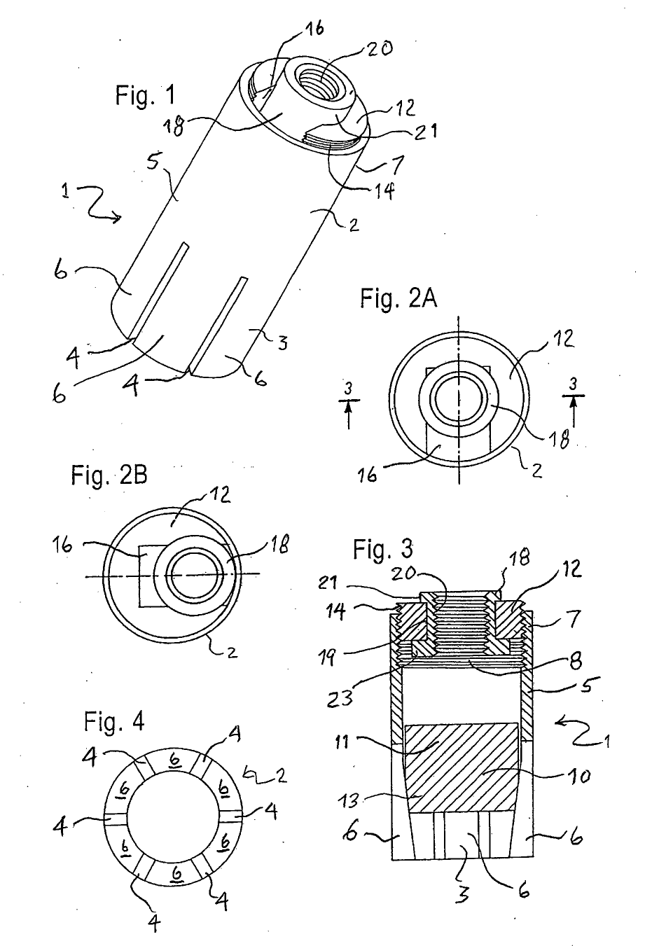

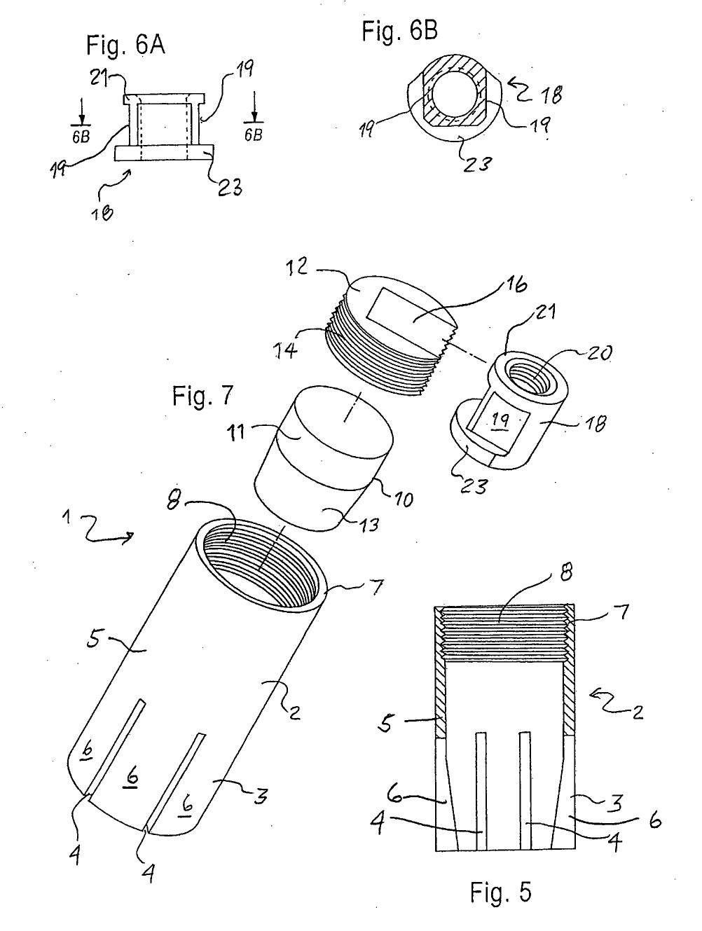

As shown in perspective view in FIG. 1, cross-sectional view in FIG. 3 and exploded view in FIG. 7, the adjustable drop-in concrete anchor 1 of the present invention includes a substantially cylindrical tubular base 2, the base 2 having a lower end portion 3 having a plurality of longitudinally extending slots 4 defining a plurality of longitudinally extending expansion walls 6. The base 2 has an upper end portion 7 with threads 8. The base 2 is more clearly shown assembled in the cross-sectional view in FIG. 3 and alone in the cross-sectional view in FIG. 5. As can be seen in FIGS. 3 and 5, the expansion walls 6 have a wall thickness greater than a wall thickness of the base in a portion 5 above the lower end portion 3. As shown in the bottom plan view of FIG. 4, in one embodiment, the adjustable drop-in concrete anchor 1 may have six longitudinally extending slots 4 defining six longitudinally extending expansion walls 6. However, the number of slots 4 and expansion walls 6 can be chosen depending on the size of the anchor and the intended application as would be apparent to those skilled in the art.

As shown in FIGS. 3 and 7, the adjustable drop-in concrete anchor 1 includes an expander plug 10 having at least portion 11 having an outside diameter slightly less than an inside diameter of the base 2 in portion 5, and greater than an inside diameter of the base 2 at the lower end portion 3. In the embodiment shown in FIGS. 3 and 7, the portion 11 of the expander plug 10 that has an outside diameter slightly less than the inside diameter of the base 2 at the lower end portion 3 is a cylindrical portion of the expander plug 10, and the expander plug 10 has a lower portion 13 having a truncated cone shape with a base of the truncated cone arranged adjacent a base of the cylindrical portion 11 at its lower end. As can be appreciated from FIGS. 3 and 7, the expander plug 10 can be inserted into the top of the base 2 and can slide freely through the portion 5. As will be apparent to those skilled in the art, with a setting tool can be used to force the expander plug 10 down into the lower portion of the base 2 to force the expansion walls 6 outwardly to secure the anchor 1 in a predrilled hole in the concrete.

As shown in FIGS. 1, 2A, 2B, 3 and 7, the anchor 1 includes an adjustment insert disk 12. The adjustment insert disk 12 has, as more clearly shown in FIGS. 1, 3 and 7, external threads 14 extending around at least part of an outer circumferential surface thereof, the external threads 14 mating with the internal threads 8 in upper end portion 7 of the base 2. The adjustment insert disk 12 has a slot 16 extending from a portion of the circumferential surface to at least a central axis thereof. In the embodiment shown in the figures, the adjustment insert disk 12 is generally C-shaped in cross-section and its slot 16 has an open end adjacent the circumferential surface of the adjustment insert disk 12. However, the slot 16 may have other configurations as long as it provides the function described hereinafter.

Because the external threads 14 mate with the internal threads 8 of the upper end portion 7 of the base 2, the adjustment insert disk 12 can be removed from the base 2 to allow use of a setting tool as described above and then replaced in the base 2. Moreover, because the external threads 14 mate with the internal threads 8 of the upper end portion 7 of the base 2, the adjustment insert disk 12 can be threaded into the base and its position adjusted up and down along a longitudinal axis of the base 2. For this reason, it is preferred that he threads 8 of the upper end portion 7 of the base 2 extend further with respect to the longitudinal axis of the base 2 than the thickness of the adjustment insert disk 12. Taking advantage of this feature, even if the concrete and/or the object to be fixed thereto does not have a perfectly flat mating surface, resulting in misalignment (in a direction perpendicular to the plane of the concrete surface) between the fixed anchor locations of the object and the concrete surface, the position of the adjustment insert disk 12 can be adjusted up or down along a longitudinal axis of the base 2 to avoid any misalignment (in a direction perpendicular to the plane of the concrete surface) between the fixed anchor locations of the object and the anchor 1.

As shown in FIGS. 1, 2A, 2B, 3 and 7 and in greater detail in FIGS. 6A and 6B, the anchor 1 includes a slidable nut 18 having an outer sliding portion 19 for sliding in the slot 16 in the adjustment insert disk 12. The nut 18 has internal threads 20 into which a bolt can be threaded for securing an object to the anchor 1. As shown most clearly in FIGS. 6A and 6B, the slidable nut 18 has an upper flange portion 21 and a lower flange portion 23 provided above and below, respectively, the outer sliding portion 19, the upper and lower flange portions 21, 23 being slidable on upper and lower surfaces, respectively of the adjustment insert disk 12.

As best seen in FIGS. 2A and 2B, the nut 18 is slidable in the slot 16 of the adjustment insert disk 12 so that an axis of the internal threads 20 of the nut 18 can be aligned with the longitudinal axis of the base 2 or can be positioned eccentric thereto. Therefore, even if the holes for the concrete anchors are not drilled accurately, i.e., at exactly the correct location, so that the plurality of fixed anchor locations on the object do not mate exactly with the longitudinal axis of the anchors once they are dropped and set in the holes, misalignment (in the plane of the concrete surface) between the fixed anchor locations and the anchors is avoided since the axis of the internal threads 20 of the nut 18 can be positioned eccentric with respect to the longitudinal axis of the base 2.

Therefore, the anchor 1 of the present invention includes means to adjust a position of the nut in a direction parallel to the longitudinal axis of the base and to adjust a position of the nut so that an axis of the internally threaded portion of the nut can be aligned with the longitudinal axis of the base or eccentric thereto. Accordingly, the present invention provides a concrete drop-in anchor that is adjustable both in the plane of the concrete surface and in a direction perpendicular to the plane of the concrete surface.

The anchor 1 of the present invention can be made with nuts 18 having internal threads 20 of standard sizes, e.g., ¼″, 5/16″, ⅜″, 7/16″, ½″, ⅝″ and ¾″ or metric sizes; the remaining elements of the anchor 1 are dimensioned accordingly as would be understood by those skilled in the art. In one embodiment of the present invention, the base 2 can be made of aluminum and the remaining elements of cold rolled steel. However, the various elements of the anchor 1 may be made of other materials as would be understood by those skilled in the art.

While the invention has been described in terms of its preferred embodiments, it should be understood that numerous modifications could be made thereto without departing from the spirit and scope of the invention as defined in the appended claims. It is intended that all such modifications fall within the scope of the appended claims.

I claim:

1. An adjustable drop-in concrete anchor, comprising:
a substantially cylindrical tubular base, the base having a lower end portion having a plurality of longitudinally extending slots defining a plurality of longitudinally extending expansion walls having a wall thickness greater than a wall thickness of the base above the lower end portion, and having an internally threaded upper end portion;
an expander plug having at least portion having an outside diameter slightly less than an inside diameter of the base above the lower end portion and greater than an inside diameter of the base at the lower end portion;
an adjustment insert disk having external threads extending around at least part of an outer circumferential surface thereof, the external threads mating with the internally threaded upper end portion of the base, and having a slot extending from a portion of the circumferential surface to at least a central axis thereof; and
a slidable nut having an outer sliding portion for sliding in the slot in the adjustment insert disk and an internally threaded portion.

2. The adjustable drop-in concrete anchor according to claim 1, wherein the portion of the expander plug having an outside diameter slightly less than the inside diameter of the base above the lower end portion and greater than the inside diameter of the base at the lower end portion is a cylindrical upper portion of the expander plug, and the expander plug has a lower portion having a truncated cone shape with a base of the truncated cone arranged adjacent a base of the cylindrical portion at its lower end.

3. The adjustable drop-in concrete anchor according to claim 1, wherein the slot in the adjustment insert disk has an open end adjacent the circumferential surface of the adjustment insert disk.

4. The adjustable drop-in concrete anchor according to claim 1, wherein the slidable nut has upper and lower flange portions provided above and below, respectively, the outer sliding portion, the upper and lower flange portions being slidable on upper and lower surfaces, respectively of the adjustment insert disk.

5. An adjustable drop-in concrete anchor, comprising:
a substantially cylindrical tubular base, the base having a lower end portion having a plurality of longitudinally extending slots defining a plurality of longitudinally extending expansion walls having a wall thickness greater than a wall thickness of the base above the lower end portion, and having an internally threaded upper end portion;
an expander plug provided in the base and having at least portion having an outside diameter slightly less than an inside diameter of the base above the lower end portion and greater than an inside diameter of the base at the lower end portion so that when the expander plug is forced downwardly in the base, the portion having an outside diameter slightly less than an inside diameter of the base above the lower end portion and greater than an inside diameter of the base at the lower end portion expands the expansion walls of the base outwardly;
an adjustment insert disk having external threads extending around at least part of an outer circumferential surface thereof, the external threads mating with the internally threaded upper end portion of the base so that the adjustment insert disk can be threaded into the base and a position thereof along a longitudinal axis of the base adjusted, the adjustment insert disk having a slot extending from a portion of the circumferential surface to at least the longitudinal axis of the base; and
a slidable nut having an outer sliding portion for sliding in the slot in the adjustment insert disk and an internally threaded portion, the nut being slidable in the slot of the adjustment insert disk so that an axis of the internally threaded portion of the nut can be aligned with the longitudinal axis of the base or eccentric thereto.

6. The adjustable drop-in concrete anchor according to claim 5, wherein the portion of the expander plug having an outside diameter slightly less than the inside diameter of the base above the lower end portion and greater than the inside diameter of the base at the lower end portion is a cylindrical upper portion of the expander plug, and the expander plug has a lower portion having a truncated cone shape with a base of the truncated cone arranged adjacent a base of the cylindrical portion at its lower end.

7. The adjustable drop-in concrete anchor according to claim 5, wherein the slot in the adjustment insert disk has an open end adjacent the circumferential surface of the adjustment insert disk.

8. The adjustable drop-in concrete anchor according to claim 5, wherein the slidable nut has upper and lower flange portions provided above and below, respectively, the outer sliding portion, the upper and lower flange portions being slidable on upper and lower surfaces, respectively of the adjustment insert disk.

9. An adjustable drop-in concrete anchor, comprising:
a substantially cylindrical tubular base, the base having a lower end portion having expansion walls able to be expanded outwardly for locking the anchor in concrete;
expansion means provided in the base for expanding the expansion walls of the base outwardly;
a nut having an internally threaded portion; and
adjustment means to adjust a position of the nut in a direction parallel to the longitudinal axis of the base and to adjust a position of the nut so that an axis of the internally threaded portion of the nut can be aligned with the longitudinal axis of the base or eccentric thereto.
